(19) United States
(12) Patent Application Publication
(10) Pub. No.: US 2009/0179842 A1
(43) Pub. Date: Jul. 16, 2009

(54) FLAT DISPLAY PANEL

(75) Inventors: Bo-Chu Chen, Hsinchu City (TW); King-Yuan Ho, Chiayi County (TW); Yung-Hui Yeh, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/203,153

(22) Filed: Sep. 3, 2008

(30) Foreign Application Priority Data
Jan. 10, 2008 (TW) 97100996

(51) Int. Cl. G09G 3/22; G09G 3/36

(52) U.S. Cl. 345/88

(57) ABSTRACT

A flat display panel is provided. The flat display panel includes a plurality of scan lines, a plurality of data lines, and a plurality of pixels arranged in an (m×n) array, in which both m and n are integers greater than 2. Each of the pixels includes four sub-pixels arranged in a (2×2) array. In each of the pixels, the sub-pixels are connected with one of the scan lines and one of the data lines correspondingly, and display different color lights, respectively. In any four pixels arranged in a (2×2) array, the four sub-pixels located at the center area display the same color light.

### CROSS-REFERENCE TO RELATED APPLICATION

This application claims the priority benefit of Taiwan application serial no. 97100996, filed on Jan. 10, 2008. The entirety of the above-mentioned patent application is hereby incorporated by reference herein and made a part of specification.

### BACKGROUND OF THE INVENTION

1. Field of the Invention

The present invention generally relates to a flat display panel, in particular, to a flat display panel with a high aperture ratio.

2. Description of Related Art

To match the modern life style, video or image devices need to be lighter and thinner. Although the conventional cathode ray tube (CRT) display has many advantages, the design of the electron gun renders it heavy and bulky. Moreover, there is always some risk of radiation emitted by the conventional CRT hurting viewers' eyes. With big leaps in the techniques in manufacturing semiconductor devices and electro-optical devices, flat panel displays such as plasma display panels (PDPs), liquid crystal displays (LCDs), organic electro-luminescence displays (OEL displays), and electronic-ink displays have gradually become mainstream display products.

Generally, the flexibility of a flat panel display depends on the selection of substrate material. When a rigid substrate, for example, glass substrate is adopted, the flat panel display is usually inflexible. On the contrary, when a flexible substrate, for example, plastic substrate is adopted, the flat panel display has excellent flexibility. Take a flexible LCD for instance. The alignment accuracy of two flexible substrates when aligned to be laminated may directly affect the aperture ratio of the display panel.

FIGS. 1A and 2A are schematic perspective views of a conventional pixel arrangement of an LCD, FIG. 1B is a schematic cross-sectional view of the LCD in FIG. 1A along cross-sectional line I-I, and FIG. 2B is a schematic cross-sectional view of the LCD in FIG. 2A along cross-sectional line II-II.

Referring to FIG. 1A, a conventional flexible LCD 100 has a plurality of pixels P, and each pixel P includes a red sub-pixel R, a green sub-pixel G, a blue sub-pixel B, and a white sub-pixel W. As shown in FIG. 1A, the arrangement of the sub-pixels R, G, B, and W in each pixel P is identical, so the sub-pixels for emitting the same color light are not adjacent to each other. In particular, each red sub-pixel R is surrounded by the blue sub-pixel B and the green sub-pixel G, each green sub-pixel G is surrounded by the red sub-pixel R and the white sub-pixel W, each blue sub-pixel B is surrounded by the red sub-pixel R and the white sub-pixel W, and each white sub-pixel W is surrounded by the blue sub-pixel B and the green sub-pixel G.

Referring to FIGS. 1A, 1B, 2A, and 2B, the conventional flexible LCD 100 includes an active device array substrate 110, a color filter 120, and an LC layer 130 disposed between the active device array substrate 110 and the color filter 120. In an ideal situation, after the active device array substrate 110 and the color filter 120 are aligned and laminated, data lines 112 on the active device array substrate 110 must be aligned with black matrix 122 on the color filter 120, as shown in FIGS. 1A and 1B. However, in practice, as the thermal expansion coefficient of a flexible substrate is quite high, the mis-alignment between the active device array substrate 110 and the color filter 120 is severe. Therefore, after the active device array substrate 110 and the color filter 120 are aligned and laminated, the black matrix 122 usually cannot be aligned with the data lines 112. In other words, an offset S exists between the black matrix 122 and the data lines 112, as shown in FIGS. 2A and 2B. When the offset S gets too large, the display quality of the flexible LCD 100 is greatly degraded.

As shown in FIGS. 1A and 2A, in the conventional pixel arrangement, each sub-pixel is surrounded by sub-pixels of different colors. In other words, when mis-alignment occurs, the conventional arrangement of the sub-pixels R, G, B, and W has low tolerance for mis-alignment. Therefore, generally, in the flexible LCD 100, in order to solve the problem of image quality degradation caused by the mis-alignment, black matrix 122 with a larger width are required to compensate the offset S. Apparently, the larger the width of the black matrix 122 is, the lower the aperture ratio of the flexible LCD 100 will be.

### SUMMARY OF THE INVENTION

Accordingly, the present invention is directed to a flat display panel. The flat display panel includes a plurality of scan lines, a plurality of data lines, and a plurality of pixels arranged in an (m×n) array, in which both m and n are integers greater than 2. Each of the pixels includes four sub-pixels arranged in a (2×2) array. In each of the pixels, the sub-pixels are connected with one of the scan lines and one of the data lines correspondingly, and display different color lights, respectively. In any four pixels arranged in a (2×2) array, the four sub-pixels located at the center area display the same color light.

In the present invention, the sub-pixels in different pixels are collectively arranged, so as to effectively improve the aperture ratio of the flat display panel.

In order to make the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 2A are schematic perspective views of a conventional pixel arrangement of an LCD.

FIG. 1B is a schematic cross-sectional view of the LCD in FIG. 1A along cross-sectional line I-I.

FIG. 2B is a schematic cross-sectional view of the LCD in FIG. 2A along cross-sectional line II-II.

FIG. 3 is a schematic perspective view of a pixel arrangement of a flat display panel according to an embodiment of the present invention.

FIG. 4 is a schematic cross-sectional view of the flat panel display in FIG. 3 along cross-sectional line III-III.

FIG. 5 is a schematic cross-sectional view of the flat panel display in FIG. 3 along cross-sectional line IV-IV.

FIG. 6 is a schematic top view of the pixel arrangement in FIG. 3.

FIG. 7 is a schematic top view of a pixel arrangement of a flat display panel according to another embodiment of the present invention.

FIGS. 8 and 9 are schematic top views of a pixel arrangement of a flat display panel according to still another embodiment of the present invention.

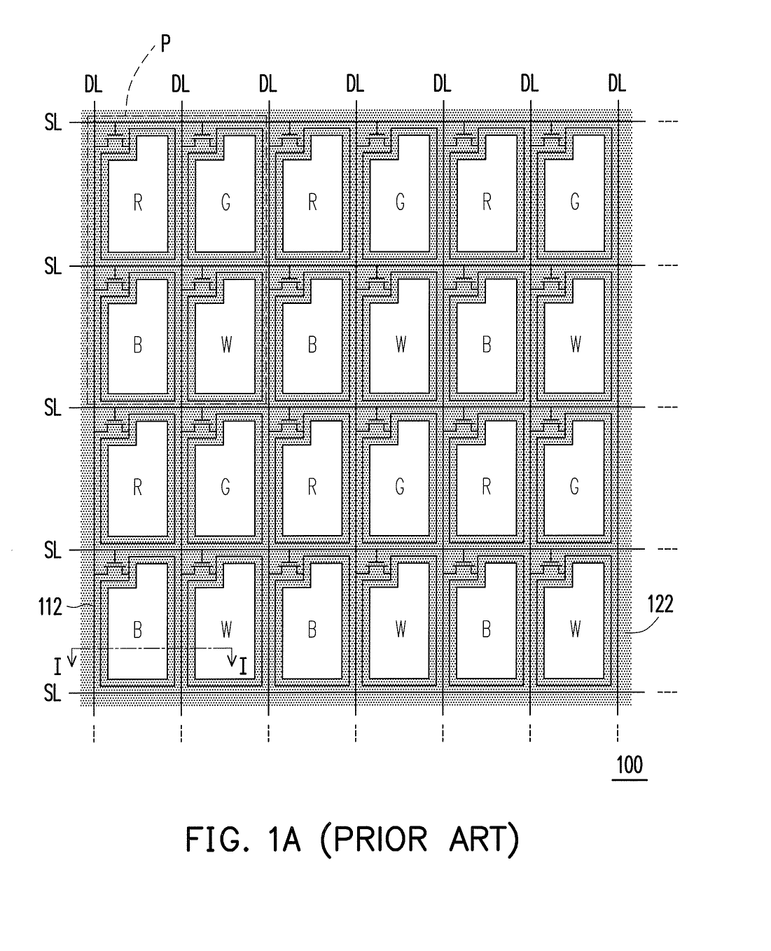

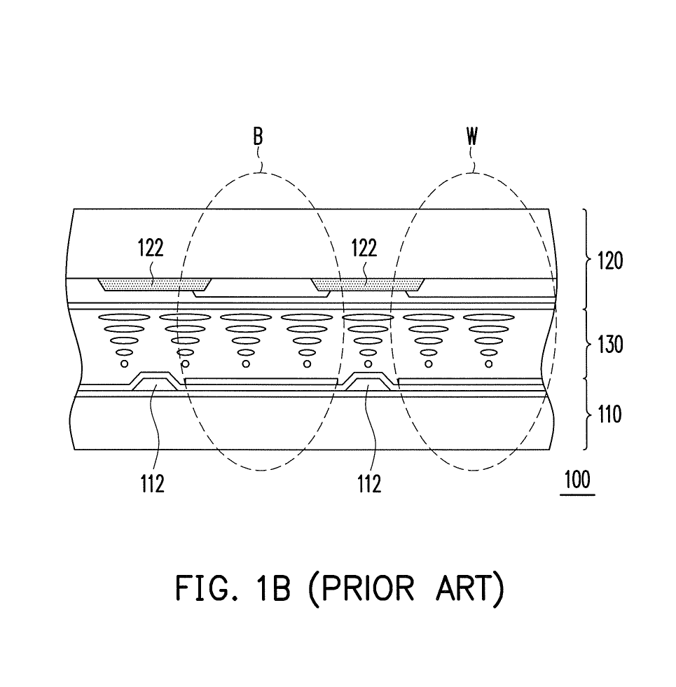

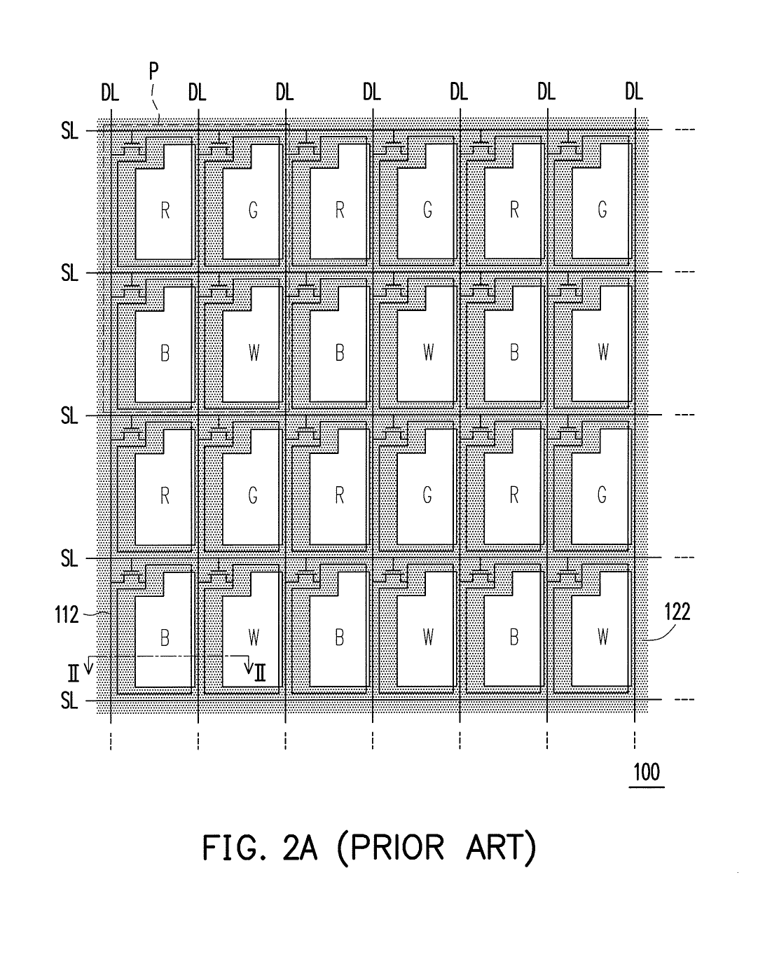

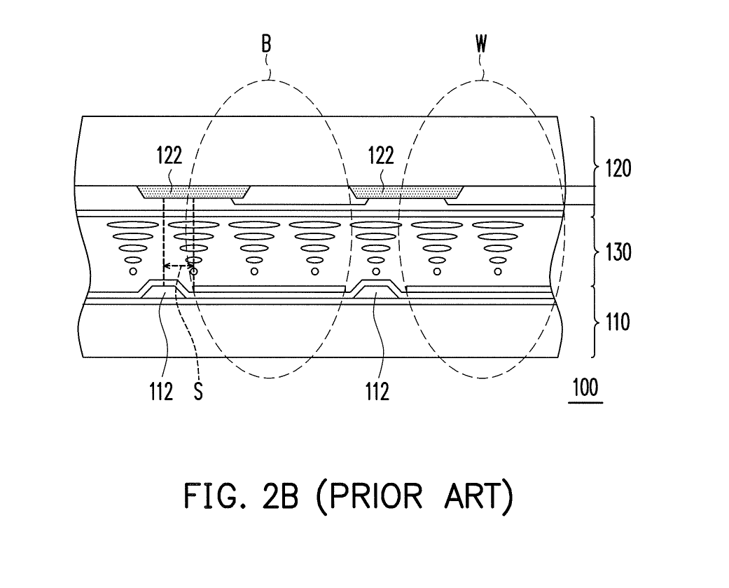

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

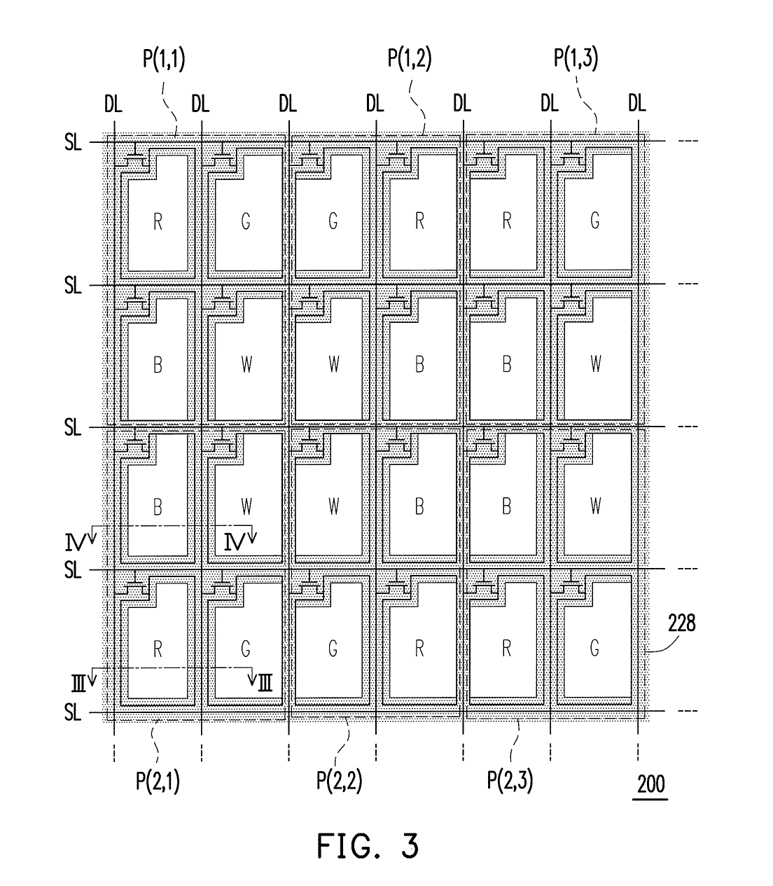

FIG. 3 is a schematic perspective view of a pixel arrangement of a flat display panel according to an embodiment of the present invention. Referring to FIG. 3, the flat display panel 200 of this embodiment includes a plurality of scan lines SL, a plurality of data lines DL, and a plurality of pixels arranged in an (m×n) array such as P_{(1,1)}, P_{(1,2)}, P_{(1,3)}, P_{(2,1)}, P_{(2,2)}, P_{(2,3)} . . . , generally referred to as pixels P_{(i,j)} below, in which both i and j are positive integers, i≦m and j≦n, and both m and n are integers greater than 2. As shown in FIG. 3, each pixel P_{(i,j)} on the flat display panel 200 includes four sub-pixels arranged in a (2×2) array, for example, a red sub-pixel R, a green sub-pixel G, a blue sub-pixel B, and a white sub-pixel W. In each pixel P_{(i,j)}, the sub-pixels R, G, B, and W are electrically connected to one of the scan lines SL and one of the data lines DL correspondingly, and display different color lights (for example, red light, green light, blue light, and white light), respectively. It should be noted that in any four pixels P_{(i,j)} arranged in a (2×2) array, the four sub-pixels located at the center area display the same color light.

Referring to FIG. 3, in an array constituted by the pixels P_{(1,1)}, P_{(1,2)}, P_{(2,1)}, and P_{(2,2)}, the four sub-pixels located at the center area are all white sub-pixels W capable of displaying white light. In addition, the green sub-pixels G in the pixels P_{(1,1)} and P_{(1,2)} are adjacent, the green sub-pixels G in the pixels P_{(2,1)} and P_{(2,2)} are adjacent, the blue sub-pixels B in the pixels P_{(1,1)} and P_{(2,1)} are adjacent, and the blue sub-pixels B in the pixels P_{(1,2)} and P_{(2,2)} are adjacent.

Similarly, in an array constituted by the pixels P_{(1,2)}, P_{(1,3)}, P_{(2,2)}, and P_{(2,3)}, the four sub-pixels located at the center area are all blue sub-pixels B capable of displaying blue light. In addition, the red sub-pixels R in the pixels P_{(1,2)} and P_{(1,3)} are adjacent, the red sub-pixels R in the pixels P_{(2,2)} and P_{(2,3)} are adjacent, the white sub-pixels W in the pixels P_{(1,2)} and P_{(2,2)} are adjacent, and the white sub-pixels W in the pixels P_{(1,3)} and P_{(2,3)} are adjacent.

In this embodiment, the arrangement of the sub-pixels in each pixel P_{(i,j)} and those of other adjacent pixels are mirror images of each other. For example, the arrangements of the sub-pixels in the pixels P_{(1,2)} and P_{(1,1)} are mirror images of each other, the arrangements of the sub-pixels in the pixels P_{(1,2)} and P_{(1,3)} are mirror images of each other, and in addition, the arrangements of the sub-pixels in the pixels P_{(1,2)} and P_{(2,2)} are also mirror images of each other.

The pixel arrangement of the present invention is applicable to any flat display panels, such as LCD panels and OEL display panels. When the aforementioned pixel arrangement is applied to an LCD panel, each pixel P_{(i,j)} may be regarded as an LCD sub-pixel, and the pixels P_{(i,j)} may be active display pixels (as shown in FIG. 3). Of course, the pixels P_{(i,j)} may also be passive display pixels (not shown). Further, in order to make the arrangement of the sub-pixels compact and regular, the shape of the sub-pixels in the pixels P_{(i,j)} is generally rectangular. It is noted that, when the aforementioned pixel arrangement is applied to an LCD panel, a backlight module using white light LEDs or CCFLs as light source can be utilized.

The LCD panel is merely taken as an example for illustration below without limiting the present invention.

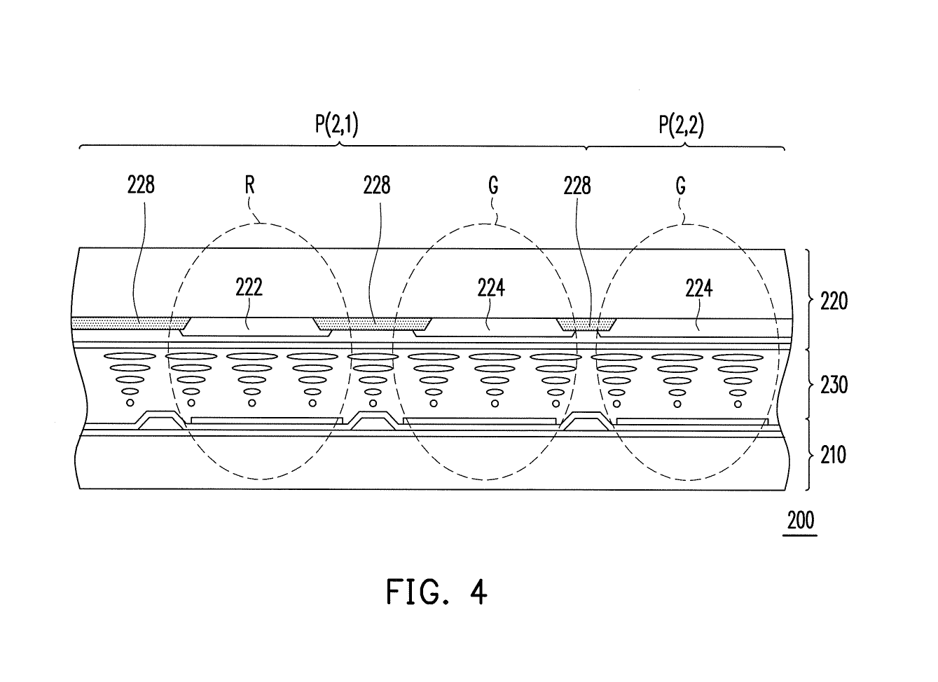

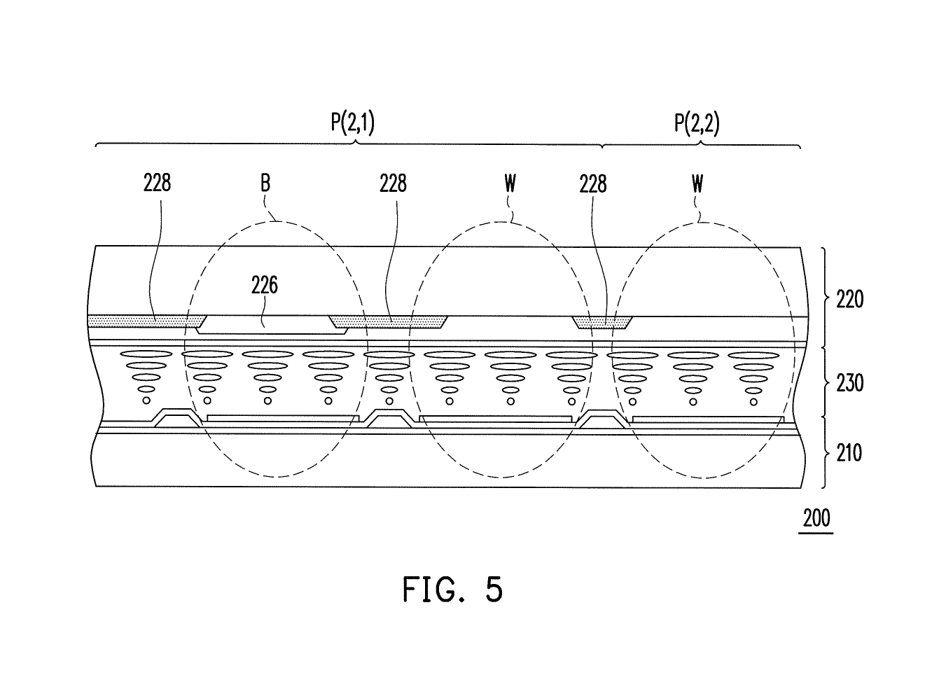

FIG. 4 is a schematic cross-sectional view of the flat panel display in FIG. 3 along cross-sectional line III-III, and FIG. 5 is a schematic cross-sectional view of the flat panel display in FIG. 3 along cross-sectional line IV-IV. Referring to FIGS. 4 and 5, in this embodiment, the flat display panel 200 includes an active device array substrate 210, a color filter 220, and an LC layer 230 disposed between the active device array substrate 210 and the color filter 220. A red sub-pixel R of the flat display panel 200 has a red filter layer 222 (as shown in FIG. 4), a green sub-pixel G thereof has a green filter layer 224 (as shown in FIG. 4), a blue sub-pixel B thereof has a blue filter layer 226 (as shown in FIG. 5), and a white sub-pixel W thereof does not have any filter layer (as shown in FIG. 5).

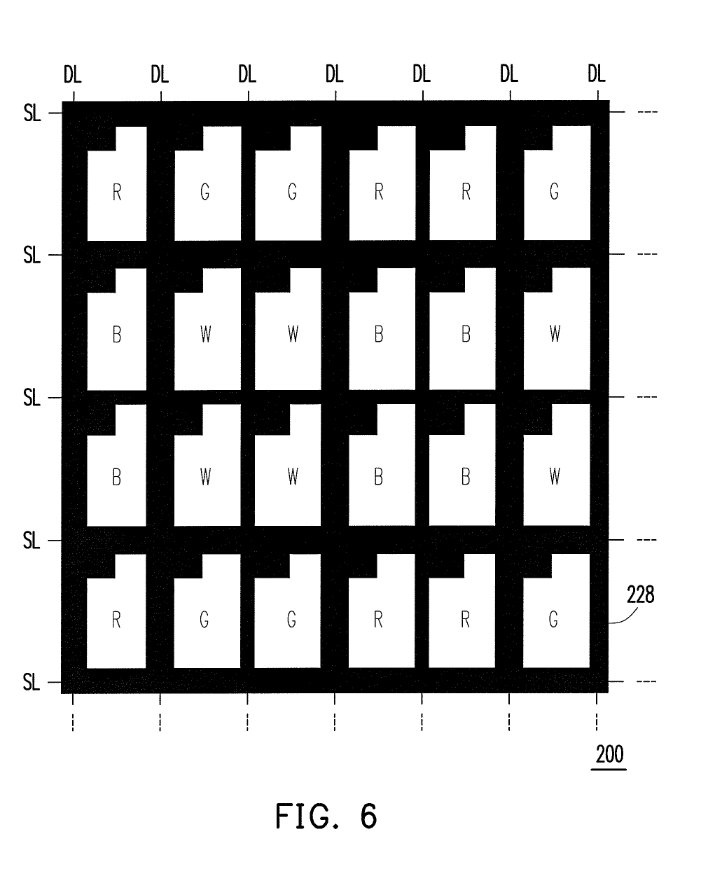

FIG. 6 is a schematic top view of the pixel arrangement in FIG. 3. Referring to FIGS. 4 to 6, as the green sub-pixels G in the pixels P_{(2,1)} and P_{(2,2)} are adjacent to each other, the width of a black matrix 228 between the two green sub-pixels G need not be too large. In addition, as the white sub-pixels W in the pixels P_{(2,1)} and P_{(2,2)} are adjacent to each other, the width of the black matrix 228 between the two white sub-pixels W also need not be too large. It can be known from FIGS. 4 and 5 that the width of the black matrix 228 on the right is apparently smaller than the widths of the two black matrix 228 on the left. When the widths of a part of the black matrix 228 can be further reduced, the aperture ratio of the flat display panel 200 will be further improved.

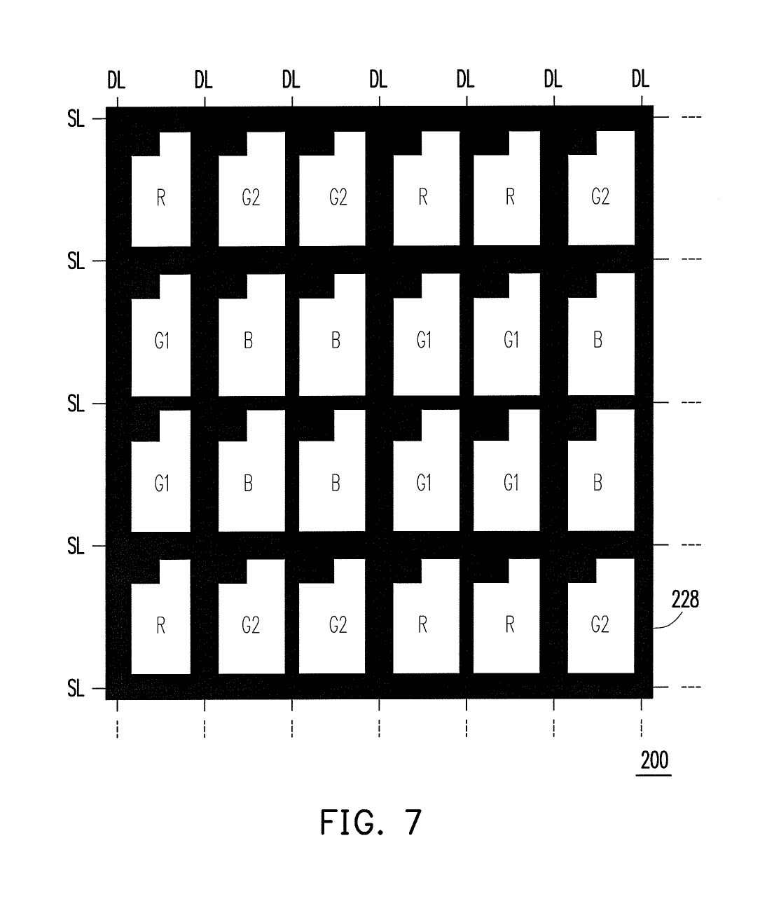

FIG. 7 is a schematic top view of a pixel arrangement of a flat display panel according to another embodiment of the present invention. Referring to FIGS. 6 and 7, the pixel arrangement of this embodiment is similar to the above, except that each pixel P_{(i,j)} in FIG. 7 includes a red sub-pixel R, a first green sub-pixel G1, a second green sub-pixel G2, and a blue sub-pixel B. In addition, the wavelengths of the green color lights displayed by the first green sub-pixel G1 and the second green sub-pixel G2 are different.

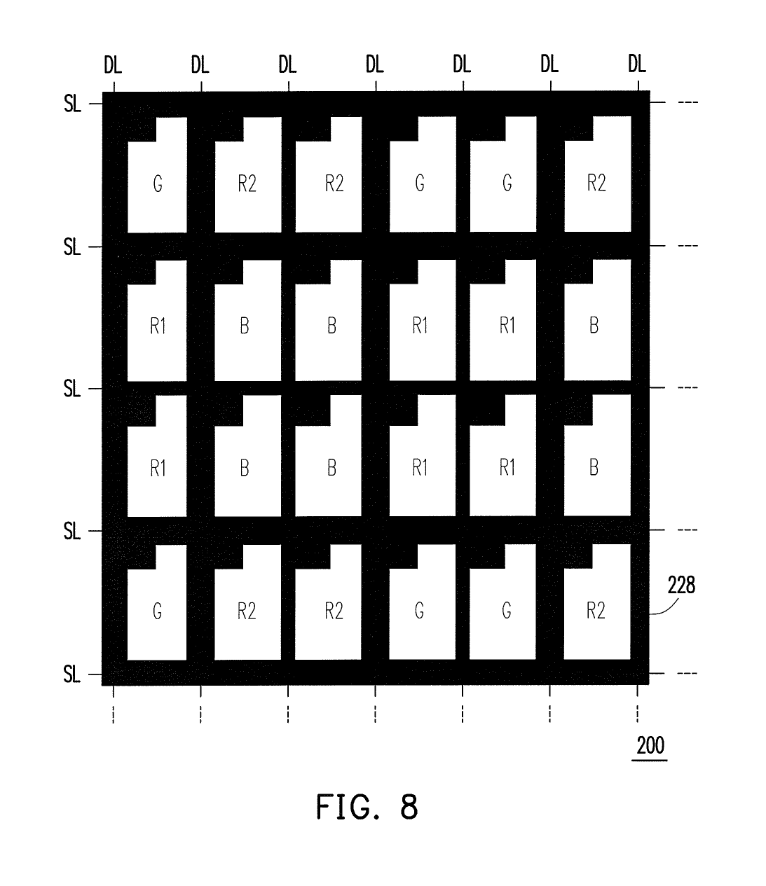

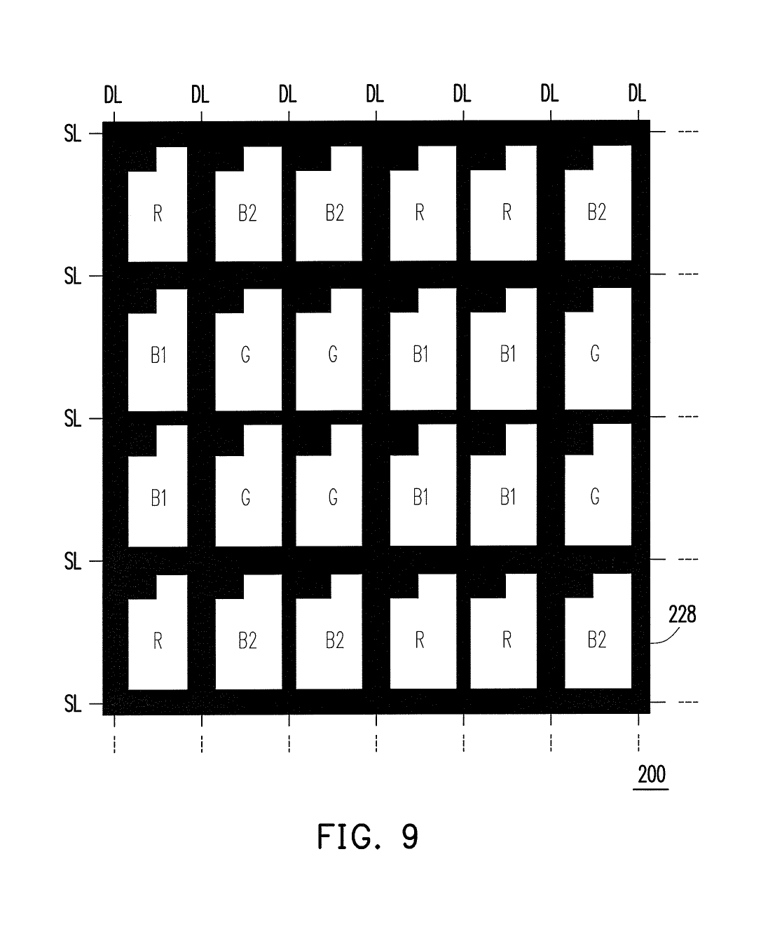

FIGS. 8 and 9 are schematic top views of a pixel arrangement of a flat display panel according to still another embodiment of the present invention. Referring to FIG. 8, each pixel P_{(i,j)} includes a first red sub-pixel R1, a second red sub-pixel R2, a green sub-pixel G, and a blue sub-pixel B, in which the wavelengths of the red color lights displayed by the first red sub-pixel R1 and the second red sub-pixel R2 are different.

Referring to FIG. 9, each pixel P_{(i,j)} includes a red sub-pixel R, a green sub-pixel G, a first blue sub-pixel B1, and a second blue sub-pixel B2, in which the wavelengths of the blue color lights displayed by the first blue sub-pixel B1 and the second blue sub-pixel B2 are different.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A flat display panel, comprising:
a plurality of scan lines;
a plurality of data lines; and
a plurality of pixels arranged in an (m×n) array, wherein both m and n are integers greater than 2; each of the pixels comprises four sub-pixels arranged in a (2×2) array; in each of the pixels, the sub-pixels are connected with one of the scan lines and one of the data lines correspondingly, and display different color lights, respectively; and in any four pixels arranged in a (2×2) array, the four sub-pixels located at the center area display the same color light.

2. The flat display panel according to claim 1, wherein the pixels comprise liquid crystal display (LCD) pixels.

3. The flat display panel according to claim 1, wherein the pixels comprise active display pixels or passive display pixels.

4. The flat display panel according to claim 1, wherein the sub-pixels in each pixel comprise a red sub-pixel, a green sub-pixel, a blue sub-pixel, and a white sub-pixel.

5. The flat display panel according to claim 4, wherein the red sub-pixel comprises a red filter layer, the green sub-pixel comprises a green filter layer, the blue sub-pixel comprises a blue filter layer, and the white sub-pixel does not comprise any filter layer.

6. The flat display panel according to claim 1, wherein the sub-pixels in each pixel comprise a red sub-pixel, a first green sub-pixel, a second green sub-pixel, and a blue sub-pixel.

7. The flat display panel according to claim 6, wherein the red sub-pixel comprises a red filter layer, the first green sub-pixel comprises a first green filter layer, the second green sub-pixel comprises a second green filter layer, and the blue sub-pixel comprises a blue filter layer.

8. The flat display panel according to claim 6, wherein wavelengths of the color lights displayed by the first green sub-pixel and the second green sub-pixel are different.

9. The flat display panel according to claim 1, wherein a shape of each sub-pixel is rectangular.
